(19) United States
(12) Patent Application Publication
(10) Pub. No.: US 2015/0055239 A1
(43) Pub. Date: Feb. 26, 2015

(54) DATA STORAGE APPARATUS AND METHOD FOR CORRECTING REPEATABLE RUNOUT

(71) Applicant: KABUSHIKI KAISHA TOSHIBA, Tokyo (JP)

(72) Inventor: Takeyori Hara, Kawasaki-shi (JP)

(73) Assignee: KABUSHIKI KAISHA TOSHIBA, Tokyo (JP)

(21) Appl. No.: 14/071,011

(22) Filed: Nov. 4, 2013

Related U.S. Application Data
(60) Provisional application No. 61/869,882, filed on Aug. 26, 2013.

(51) Int. Cl. G11B 5/596

(52) U.S. Cl. CPC G11B 5/59627; G11B 5/59616; G11B 5/59655
USPC 360/48; 360/77.04

(57) ABSTRACT

According to one embodiment, a data storage apparatus includes a disk, a head and a controller. In each track, first and second correction values for correcting a track runout in synchronization with rotation of the disk are recorded. The first correction value is for a first position located within a first track, and the second correction value is for a second position located within a second track adjacent to the first track, and separated from the first track by a predetermined distance. The head writes data to or read data from the tracks. The controller corrects the track runout with the first and second correction values, when the head is controlled to position at a target track.

### CROSS-REFERENCE TO RELATED APPLICATIONS

This application claims the benefit of U.S. Provisional Application No. 61/869,882, filed Aug. 26, 2013, the entire contents of which are incorporated herein by reference.

### FIELD

Embodiments described herein relate generally to a data storage apparatus and a repeatable runout (RRO) correction method.

### BACKGROUND

In disk storage apparatuses (disk drives) typified by hard disk drives (HDDs), magnetic heads (hereinafter heads) write and read data to and from tracks in a storage area of a disk. In this case, an HDD controller executes a servo control to cause the heads to be positioned at a desired track.

It should be noted that in HDDs, a runout occurs in synchronism with rotation of the disk. This is referred to as a repeatable runout (RRO). Among such RRO, an RRO occurring due to displacement of servo information is referred to as a servo written RRO. The servo written RRO is not caused by actual displacement of a head; it is caused by displacement of written position information. Thus, when the head follows the written position information, it is not accurately positioned with respect to a track. Therefore, at the time of exerting the servo control, the controller executes an RRO correction on an apparent displacement due to the servo written RRO, using an RRO correction value. RRO correction values are recorded in RRO areas of servo sectors included in each of tracks. The RRO correction values comprise RRO correction values correspond to a write position and a read position, respectively. The write position is a write track center, i.e., a position at which a write head is located when being positioned at the center of a track to be formed at the time of writing data, and the read position is a read track center, i.e., a position at which a read head is located when being positioned at the center of the track at the time of reading written data.

Such conventional RRO correction values as described above vary in accordance with the offset distance between the heads, if a non-correlation component between adjacent tracks is increased. Thus, with respect to the write track center and the read track center, learned RRO correction values differ from ideal correction values. This gives rise to a problem in the case where data is written to an area close to a boundary of a write permission area, with an external disturbance caused during tracking or settling of a seek operation.

### BRIEF DESCRIPTION OF THE DRAWINGS

FIG. 1 is a block diagram of a structure of a disk drive according to an embodiment.

FIG. 2 is a view for explaining an example of a servo sector in the embodiment.

FIG. 3 is a view for explaining a positional relationship between a servo burst area and an RRO field in the embodiment.

FIG. 4 is a flowchart for explaining processing for writing an RRO correction value in the embodiment.

FIG. 5 is a view for showing a weighting function of RRO correction values in the embodiment.

FIG. 6 is a flowchart for explaining application of an RRO correction value in a data write operation in the embodiment.

FIG. 7 is a flowchart for explaining application of the RRO correction value in a data read operation in the embodiment.

FIG. 8 is a view for explaining a positional relationship between a servo burst area and an RRO field in another embodiment.

FIG. 9 is a view for explaining an example of a servo sector in the other embodiment.

FIG. 10 is a flowchart for explaining processing for writing an RRO correction value in the other embodiment.

### DETAILED DESCRIPTION

In general, according to one embodiment, a data storage apparatus comprises a disk, a head and a controller. In the disk, tracks are arranged as data storage areas in a radius direction of the disk. In each of the tracks, first and second correction values for making a correction for a track runout in synchronization with rotation of the disk are recorded.

The first correction value is a correction value for a first position located within a first track, and the second correction value is a correction value for a second position which is located within a second track adjacent to the first track, and which is separated from the first track by a predetermined distance. The head writes or read data to or from the tracks. The controller makes the correction for the track runout with the first and second correction values, when controlling the head to position it at a target one of the tracks.

Embodiments will be hereinafter described with reference to the accompanying drawings.

[Structure of a Disk Drive]

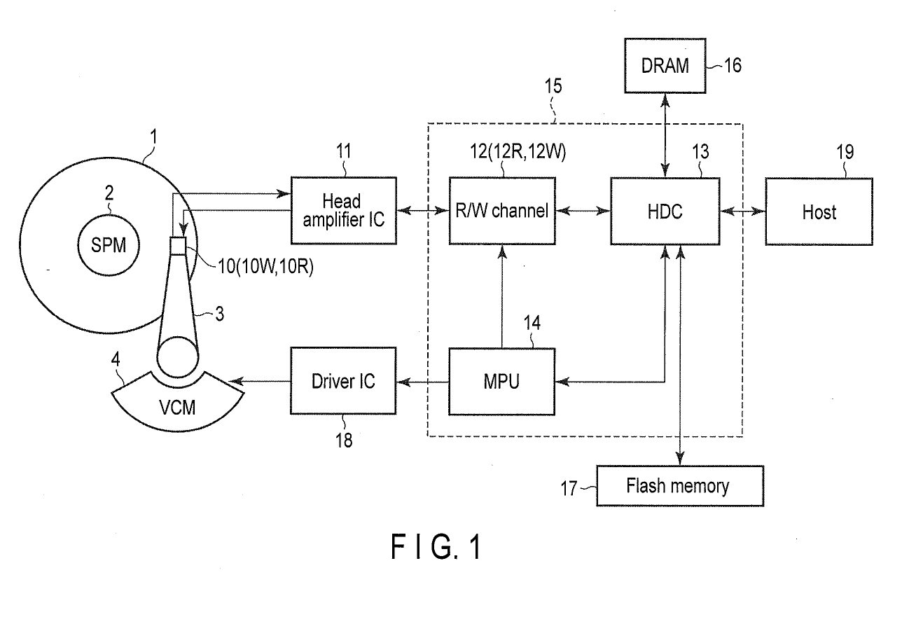

FIG. 1 is a block diagram of a main portion of a hard disk drive (hereinafter a disk drive) according to an embodiment.

As shown in FIG. 1, the disk drive comprises a head-disk assembly (HDA), a head amplifier integrated circuit (hereinafter a head amplifier IC) 11, a controller 15 and a driver IC 18.

The HDA comprises a disk 1 which is a storage medium, a spindle motor (SPM) 2, an arm 3 at which heads 10 are provided, and a voice coil motor (VCM) 4. The disk 1 is rotated by the spindle motor 2. The arm 3 and the VCM 4 are provided as an actuator to move the heads 10 to a target position (seek operation). To be more specific, the actuator moves the heads 10 provided at the arm 3 in a radius direction of the disk 1 by driving the VCM 4. The VCM 4 is driven by drive current from the driver IC 18.

The disk 1 comprises a plurality of tracks where data is recorded. The heads 10 comprise sliders as main bodies, and are provided as a write head 10W and a read head 10R provided at the sliders. The read head 10R reads data recorded in each of the tracks of the disk 1. The read data is user data or servo information which will be described later. The write head 10W writes user data to the disk 1.

The head amplifier IC 11 comprises a read amplifier and a write driver. The read amplifier amplifies a signal read by the read head 10R, and transmits it to a read/write (R/W) channel 12. On the other hand, the write driver supplies a write current to the write head 10W in accordance with write data output from the R/W channel 12.

The controller 15 is provided as an integrated circuit on a single chip, which comprises the R/W channel 12, a hard disk controller (HDC) 13 and a microprocessor (MPU) 14. The R/W channel 12 comprises a read channel 12R and a write channel 12W. The read channel 12R decodes data (including servo data) by processing the signal read by the read head 10R. The write channel 12W executes a signal processing on write data from the HDC 13.

The HDC 13 controls transmission of data between the host 19 and the R/W channel 12. The HDC 13 controls a buffer memory (DRAM) 16, and temporarily stores read data and write data in the buffer memory 16 to control transmission of the data. Also, the HDC 13 controls a flash memory 17, and uses it as, e.g., a cache area for temporarily storing data.

There is a case where the MPU 14 is referred to as a microcontroller. The MPU 14 executes a positioning control (servo control) of the heads 10 by controlling the VCM 4 with the driver IC 18. Furthermore, the MPU 14 controls recording and reproduction of data through the R/W channel 12.

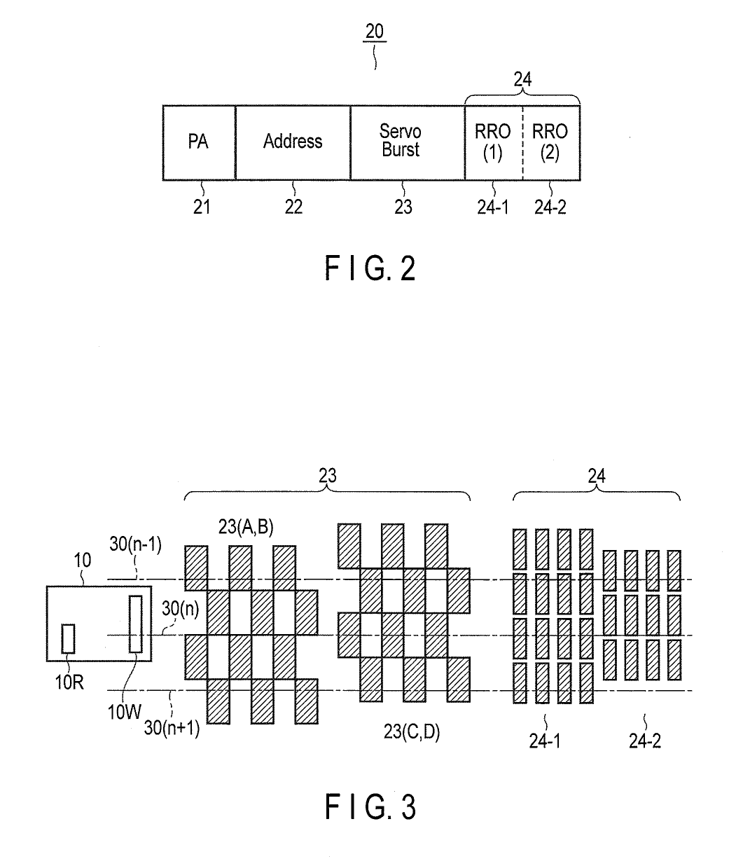

As shown in FIG. 2, in the tracks formed at the disk 1, servo sectors 20 are provided. In each of the servo sectors 20, servo information necessary for servo control is recorded. The servo sector 20 comprises areas 21-24 in which a preamble (PA) included in the servo information, addresses (a track address and a sector address), a servo burst and repeatable runout (RRO) correction values are recorded. The RRO means a track runout which synchronizes with the rotation of the disk 1.

With respect to the embodiment, an area 24 where the RRO correction values are recorded is referred to as an RRO bit field (hereinafter an RRO field). The RRO field 24 is divided into an area where a track center RRO correction value (1) 24-1 for a track center is recorded and an area where a track boundary RRO correction value (2) 24-2 for a track boundary is recorded. The RRO correction values 24-1 and 24-2 are both data comprising Manchester codes calculated from learning processing (measurement processing). It should be noted that although it is described above that the RRO correction values 24-1 and 24-2 are recorded in the divided areas of the RRO field 24, the RRO correction values 24-1 and 24-2 may be dividedly recorded in different servo sectors. To be more specific, for example, track center RRO correction values (1) may be recorded in even servo sectors, and track boundary RRO correction values (2) may be in odd servo sectors.

FIG. 3 is a view for showing a positional relationship between a servo burst area 23 and the RRO field 24. As shown in FIG. 3, the servo burst area 23 and the RRO field 24 are adjacent to each other. In the servo burst area 23, a servo burst is recorded which comprises two servo burst patterns having different phases, i.e., a servo burst pattern A, B and a servo burs pattern C, D. It should be noted that in the servo burst area 23, a servo burst comprising a Null servo burst pattern (N, Q) may be recorded. The controller 15 controls the read head 10R or the write head 10W to position it in units of, e.g., ½ track, based on the servo burst read by the read head 10R.

[Recording of RRO Correction Value]

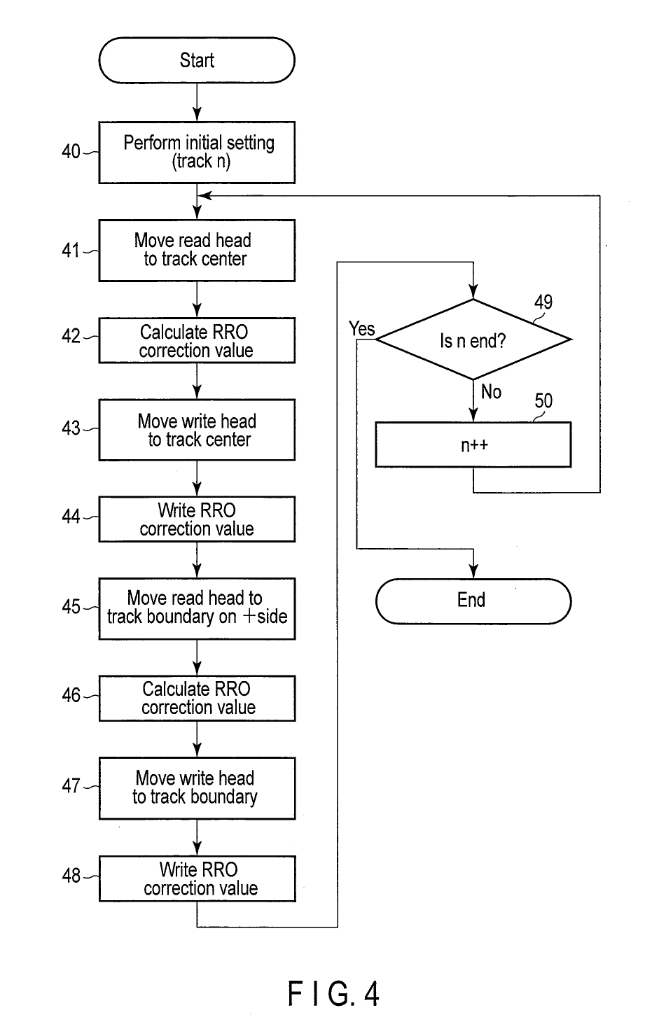

A process for writing an RRO correction value in the embodiment will be explained with reference to FIG. 3 and a flowchart of FIG. 4.

The controller 15 initially sets a center of a track n which is a control reference position for controlling the heads 10 (block 40). The track n is a data track. The controller 15 executes a servo control to position the read head 10R at the center of the track n (block 41). In a concrete example, as shown in

FIG. 3, the read head 10R is positioned at a center 30(n) of the track n. In this state, the controller 15 executes learning processing for eliminating an influence of the RRO using a result of a position error calculation made based on the servo burst read by the read head 10R. That is, the controller 15 calculates an RRO correction value (1) 24-1 by executing learning processing regarding the center of the track (block 42). It should be noted that the RRO correction value is calculated from a position error in the servo control, using a reverse characteristic of a position error compression characteristic of the servo control.

Next, the controller 15 executes the servo control to position the write head 10W at the center of the track n (block 43). That is, the write head 10W can write data while being located at the center 30(n) of the track n. Thereby, the read head 10R can read written data while the write head 10W is located at the center 30(n). The controller 15 writes the calculated RRO correction value (1) 24-1 to the RRO field 24 with the positioned write head 10W (block 44).

Furthermore, the controller 15 executes the servo control to move the read head 10R from the center 30(n) of the track n and position it at, e.g., a track boundary between the track n and another track located at an inner radius (which will be hereinafter referred to as a + side as a matter of convenience) than the track n (block 45). In a concrete example, as shown in FIG. 3, the read head 10R is positioned at a boundary between the track n (a track having the center 30(n)) and a track n+1 (a track having a center 30(n+1)). That is, the read head 10R is positioned at a position which is shifted from the track center 30(n) by a distance half a track pitch toward the + side in a radius direction of the disk. In this state, the controller 15, as described above, executes learning processing regarding the track boundary based on the servo burst read by the read head 10R to calculate a track boundary RRO correction value (2) 24-2 for the track boundary (block 46).

Next, the controller 15 executes the servo control to position the write head 10W at the above track boundary of the track n which is located on the + side (block 47). That is, the write head 10W can write data while being located at the track boundary on the + side of track n. Thereby, the read head 10R can read written data while the write head 10W is located at the track boundary. The controller 15 writes the calculated RRO correction value (2) 24-2 to the RRO field 24 with the positioned write head 10W (block 48).

Then, in the same manner as described above, the controller 15 repeats the above processing until writing of RRO correction values is completed with respect to all tracks (No in block 49). To be more specific, the controller 15 sets a subsequent control reference position for controlling the heads 10, and repeatedly carries out the above steps from the block 41 (block 50). The subsequent control reference position is a position (which will hereinafter be referred to as an n++ as a matter of convenience) which is shifted from the initially set position n by the track pitch toward the + side in the radius direction of the disk.

[Data Write and Read Operations]

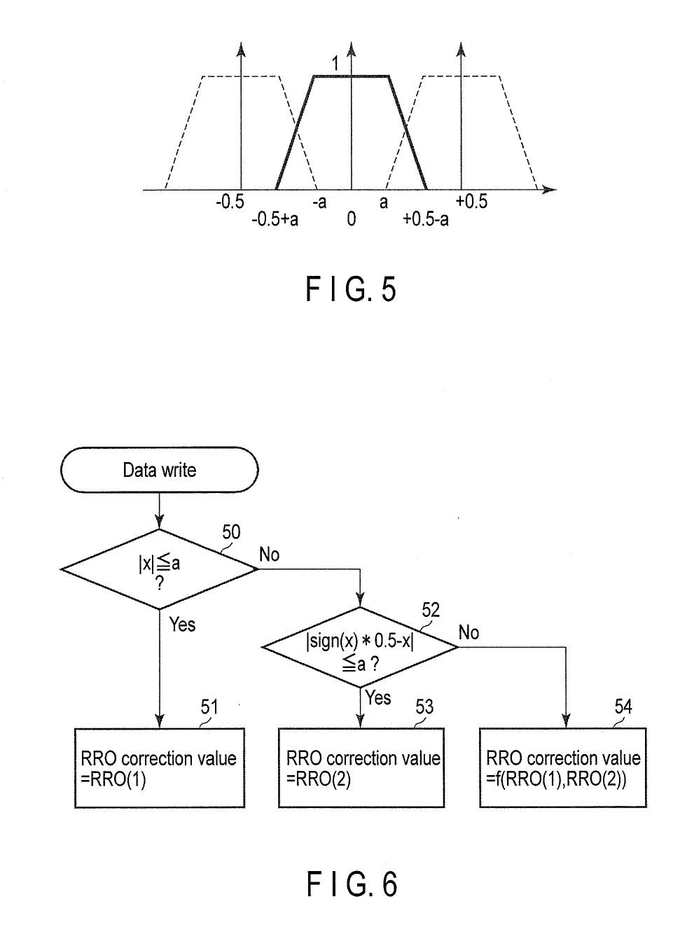

In the servo control in each of a data write operation and a data read operation, how to apply recorded RRO correction values will be explained with reference to FIGS. 5-7.

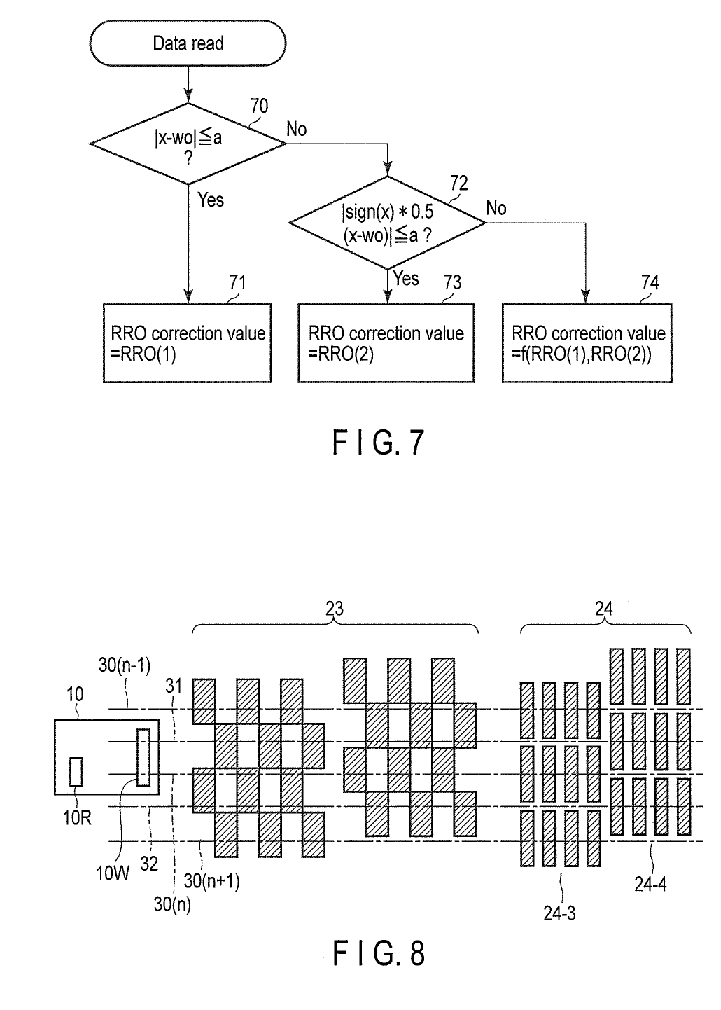

FIG. 5 is a view for explaining a concept of a weighting function in the case where RRO correction values are applied, as described later. With respect to the weighting function, referring to FIG. 5, at an offset position where data can be read from only one of a track center and a track boundary, a weight assigned to said one of the track center and the track boundary is 1, and that to the other is 0. The following detailed explanation will be given with reference to the flowcharts of FIGS. 6 and 7.

How to apply an RRO correction value in the servo control at the time of performing the data write operation will be explained with reference to the flowchart of FIG. 6.

If an absolute value of the distance between a present position x and the control reference position read by the read head 10R falls within a range corresponding to a central area of a target position (an area between +a and −a) (Yes in block 50), the controller 15 applies a track center RRO correction value (1) (24-1 in FIG. 3) (block 51). In this case, since the read head 10R is located at a track center, the track center RRO correction value (1) is applied as it is, without being subjected to be weighted.

On the other hand, if the present position x is separated from the track center (No in block 50), the controller 15 determines whether a track boundary RRO correction value (2) (24-2 in FIG. 3) for a track boundary can be applied as it is or not (block 52). To be more specific, as shown in FIG. 5, if the read position x satisfies the condition “the absolute value (sign x*0.5−x) a, where the sign x is + or −” (Yes in block 52), the controller 15 applies the track boundary RRO correction value (2) as it is (block 53). By contrast, if the read position x does not satisfy the above condition (No in block 52), the controller 15 applies as RRO correction values, predetermined function values f obtained by assigning weights to the track center RRO correction value (1) and the track boundary RRO correction value (2) (block 54).

Next, how to apply an RRO correction value in the servo control at the time of performing the data read operation will be explained with reference to the flowchart of FIG. 7.

If an absolute value of a distance between a present position (x-WO) and the control reference position read by the read head 10R falls within the range corresponding to the central area of the target position (area between +a and −a) (Yes in block 70), the controller 15 applies the RRO correction value (1) for the track center as it is (block 71), where WO denotes a write offset between the read head 10R and the write head 10W. That is, at the time of performing the data read operation, in order to read out data written by the write head 10W, the position of the read head 10R is corrected to be shifted by WO.

On the other hand, if the present position (x-WO) is separated from the track center (No in block 70), the controller 15 determines whether or not the track boundary RRO correction value (2) can be applied as it is (block 72). That is, if the read position satisfies the condition “absolute value (sign x*0.5−(x-WO)) a, where sign x is + or −” (Yes in block 72), the controller 15 applies the track boundary RRO correction value (2) as it is (block 73). By contrast, if the read position X does not satisfy the above condition (No in block 72), the controller 15 applies as RRO correction values, predetermined function values f obtained by assigning weights to the track center RRO correction value (1) and the track boundary RRO correction value (2) (block 74).

As described above, according to the embodiment, in, e.g., a manufacturing process of a disk drive, track center RRO correction values (1) 24-1 and track boundary RRO correction values (2) 24-2 are calculated, and recorded in the RRO fields 24 of servo sectors in the disk 1. In either the data write operation or the data read operation, the controller 15 applies the track center RRO correction value (1) at the time of performing the servo control, if the write head or the read head is positioned at the track center area. Furthermore, in an intermediate area separate from the track center area (e.g., in the vicinity of a track boundary area between adjacent tracks), the controller 15 applies the track boundary RRO correction value (2).

Therefore, in the case where the head 10 is positioned at either the track center or in the intermediate area, the controller 15 can apply the RRO correction value at the time of performing the servo control. Thereby, the RRO correction can be made with a high precision at the time of performing the servo control, as compared with the case of applying an RRO correction value calculated with respect to a track center in a conventional writing or reading operation.

In the embodiment, the track boundary RRO correction value (2) for the track boundary is calculated by learning processing regarding the track boundary. However, the way of calculating the track boundary RRO correction value (2) is not limited to the above way; that is, the track boundary RRO correction value (2) may be calculated from the track center RRO correction values (1) for the track centers of tracks located adjacent to each other between the above track boundary. Furthermore, the RRO correction at the position of the write head (a correction position for an offset opposite to a write/read offset) at the time of writing the RRO correction value to the RRO field 24 can be made by developing, on a memory, a track center RRO correction value (1) in the vicinity of the above position and a track boundary RRO correction value (2) for the track boundary, and calculating the weighted average.

### Other Embodiments

FIG. 8 is a view for showing a structure of servo sectors in another embodiment. In this embodiment, learning processing for calculating an RRO correction value is executed with reference to a servo track set as a reference position, not a data track.

To be more specific, as shown in FIG. 8, the controller 15 executes learning processing for calculating an RRO correction value in units of 1/N servo track, and writes obtained RRO correction values 24-3 and 24-4 for learning positions for which the learning processing is executed, to respective areas of the RRO field 24. That is, the learning positions are determined with respect to areas into which an area between the center 30(n) of a servo track and the center 30(n+1) of an adjacent servo track is divided into N (e.g., 2). If the above area is divided into two, the learning positions are a servo track center and a servo track boundary. In this case, N is determined to satisfy the condition “W/2N<M”, where W is a servo track width, and M is a read offset margin in the case where the RRO correction value is read by the read head 10R. Furthermore, if the servo track width W is smaller than an erase width E, the amount of offset at the time of writing the RRO correction value is adjusted by “(E−W)/2” to cause the center of the read offset margin to coincide with the center of the servo track.

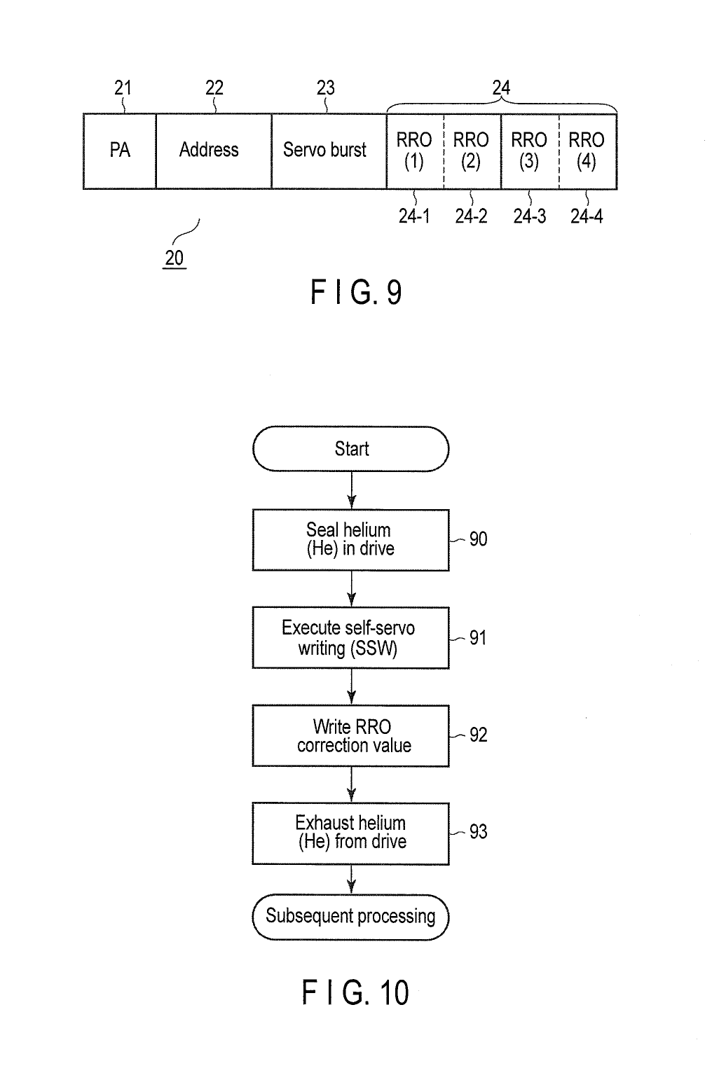

FIG. 9 is a view showing an example of a state of the RRO field 24 in the embodiment, in which RRO correction values (1) 24-1 to (4) 24-4 calculated regarding learning positions in the case where the above area is divided into four, i.e., N is four, are recorded.

In order to satisfy the condition “W/2N<M”, the number of RRO fields may be increased instead of N, and RRO fields may be arranged in a staggered manner, to increase the read offset margin.

FIG. 10 is a flowchart for explaining processing for writing an RRO correction value in the embodiment.

The embodiment is directed to a method of writing an RRO correction value immediately after executing self-servo writing (SSW) in which the disk drive itself writes servo information on the disk 1.

To be more specific, in an SSW step, first, helium (He) is sealed in the disk drive (block 90). This sealing of helium (He) can prevent an influence of a non-repeatable runout (NRRO) upon the SSW step.

In such a state, the controller 15 carries out the SSW processing, and as described above, writes servo information including a PA, addresses and a servo burst to each areas 21-23 of the servo sector 20 (block 91). Furthermore, just after the SSW, the controller 15 executes such processing for writing RRO correction values as described above (block 92). When the SSW step ends, helium (He) is exhausted from the disk drive (block 93).

In such a manner, according to the embodiment, learning processing is executed in which an RRO correction value is calculated with reference to a servo track determined as a reference position. Therefore, even if it is not determined how to configure data tracks (even if a data track pitch is not determined), it is possible to execute processing for calculating and writing an RRO correction value. To be more specific, in the case where a data track center is determined as a reference position, it is necessary to perform variable format adjustment processing to determine the configuration of the data tracks. In the embodiment, since the learning processing for calculating the RRO correction value can be executed before determination of the data track pitch, it is possible to shorten the time required for the learning processing, and efficiently performing the processing. At the time of carrying out the SSW step, with helium (He) sealed in the disk drive, the leaning processing for calculating the RRO correction value is executed, as a result of which the influence of the NRRO can be prevented, and the learning processing can be executed for a shorter time period and with a higher precision.

It should be noted that it is confirmed that in the case where a servo pattern causes an RRO among main factors that causes an RRO, it has a great influence upon displacement of an edge portion of the servo pattern in the radius direction of the disk, and if the servo pattern and another servo pattern having an edge portion which is displaced to a similar extent to that of the above former servo pattern are decoded, those servo patterns have a high correlation with each other in decoding. In the embodiment, since an RRO correction value is calculated with reference to a servo track determined as a reference position, and at the time of performing the servo control, an RRO correction can be made with the RRO correction value with a high precision.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A data storage apparatus comprising:
a disk comprising tracks which are arranged as data recording areas in a radius direction of the disk, and in each of tracks, N correction values including first and second correction values for making a correction for a track runout in synchronization with rotation of the disk are recorded, the first correction value being a correction value for a first position located within a first track, the second correction value being a correction value for a second position which is located within a second track adjacent to the first track, and which is separated from the first position by a predetermined distance, and the N correction values being obtained with learning at each of N positions into which an area between a center of the first track and a center of the second track is divided into N, N being a positive integer more than one;
a head configured to write or read data to or from the tracks; and
a controller configured to make the correction for the track runout with two of the first to N-th correction values, which are obtained for positions close to a target one of the tracks, when the head is controlled to be positioned at the target track.

2. The data storage apparatus of claim 1, wherein the controller is configured to:
make the correction for the track runout with the first correction value when the head is controlled to be positioned at a track center as the first position; and
make the correction for the track runout with the second correction value when the head is controlled to be positioned at a track boundary as the second position.

3. The data storage apparatus of claim 1, wherein
the controller is configured to make the correction for the track runout with calculating a weighted average of the first and second correction values when the head is controlled to be positioned at a position located between the first and second positions.

4. The data storage apparatus of claim 1, wherein the first and second correction values are written to respective servo sectors as recording areas for servo information, which are provided in the tracks, respectively.

5. The data storage apparatus of claim 4, wherein the first and second correction values are written to respective repeatable runout (RRO) areas of the servo sectors.

6. The data storage apparatus of claim 1, wherein the first and second correction values are written to first and second servo sectors included in one of the tracks, respectively.

7. The data storage apparatus of claim 1, wherein the first and second correction values are calculated by learning processing which is executed, with respective data track centers set as reference positions, and are written to the tracks, respectively.

8. The data storage apparatus of claim 1, wherein the first and second correction values are calculated by learning processing which is executed, with respective servo track centers set as references positions, and are written to the tracks, respectively.

9. (canceled)

10. A method of correcting a track runout in a disk storage apparatus comprising a disk and a head, the disk comprising tracks which are arranged as data recording areas in a radius direction of the disk, and in each of tracks, N correction values including first and second correction values for making a correction for the track runout are recorded, the first correction value being a correction value for a first position located within a first track, a second correction value being a correction value for a second position which is located within a second track adjacent to the first track, and which is separated from the first position by a predetermined distance, and the N correction values being obtained with learning at each of N positions into which an area between a center of the first track and a center of the second track is divided into N, N being a positive integer more than one,
the method comprising:
controlling the head to be positioned at a target one of the tracks when the head is operated to write or read data to or from the tracks; and
making the correction for the track runout with two of the first to N-th correction values, which are obtained for positions close to a target one of the tracks, when the head is controlled to be positioned at the target track.

11. The method of claim 10, further comprising:
making the correction for the track runout with the first correction value when the head is controlled to be positioned at a track center as the first position; and
making the correction for the track runout with the second correction value when the head is controlled to be positioned at a track boundary as the second position.

12. The method of claim 10, further comprising:
making the correction for the track runout with calculating a weighted average of the first and second correction values when the head is controlled to be positioned at a position located between the first and second positions.

13. The method of claim 10, wherein the first and second correction values are written to respective servo sectors as recording areas for servo information, which are provided in the tracks, respectively.

14. The method of claim 13, wherein the first and second correction values are written to respective repeatable runout (RRO) areas of the servo sectors.

15. The method of claim 10, wherein the first and second correction values are written to first and second servo sectors included in one of the tracks.

16. The method of claim 10, wherein the first and second correction values are calculated by learning processing which is executed, respective data track centers set as reference positions, and are written to the tracks, respectively.

17. The method of claim 10, wherein the first and second correction values are calculated by learning processing which is executed, with respective servo track centers set as reference positions, and are written to the tracks, respectively.

18-19. (canceled)
